(19) United States
(12) Patent Application Publication
(10) Pub. No.: US 2008/0024773 A1
(43) Pub. Date: Jan. 31, 2008

(54) Surface inspection apparatus and surface inspection method

(76) Inventors: Yusuke Miyazaki, Hitachinaka (JP); Takayuki Ono, Hitachinaka (JP); Takahiro Jingu, Takasaki (JP); Kenichiro Komeda, Hitachinaka (JP); Kazuhiro Zama, Mito (JP)

Correspondence Address: MCDERMOTT WILL & EMERY LLP, 600 13TH STREET, N.W., WASHINGTON, DC, 20005-3096, US

(21) Appl. No.: 11/711,863

(22) Filed: Feb. 28, 2007

(30) Foreign Application Priority Data
Jul. 31, 2006 (JP) 2006-208129

(51) Int. Cl. G01N 21/88

(52) U.S. Cl. 356/237.2

(57) ABSTRACT

A surface inspection apparatus comprises a radiation mechanism for radiating a light beam to the surface of an object having an edge of a non-flat surface (for example, a rounded edge) or an edge of an inclined surface, a scanning mechanism for moving the object relative to a radiation position of the light beam for scanning, and a detector for detecting light scattered from the object, and further includes the following characteristic. The scanning mechanism, when the light beam for scanning is radiated to the edge of the object, is configured to move the object in the direction that increases an incident angle of the light beam with a normal to the surface of the edge as the objection moves relative to a radiation position of the light beam.

### CLAIM OF PRIORITY

The present application claims priority from Japanese application serial No.2006-208129, filed on Jul. 31, 2006, the contents of which is hereby incorporated by references into this application.

### BACKGROUND OF THE INVENTION

The present invention relates to a surface inspection apparatus and a surface inspection method. For example, the present invention is suited to a semiconductor surface inspection apparatus for inspecting a surface of a semiconductor wafer for foreign substances and defects in manufacturing processes of semiconductor devices.

In the manufacturing processes of semiconductor devices, a pattern is transferred onto each wafer surface and a circuit is formed by etching. In the manufacturing processes of various semiconductor devices to form this circuit, foreign substances and defects adhered to the wafer surface are large factors for reducing yields. Therefore, foreign substances and defects adhered to the wafer surface are checked in each manufacturing process and measures for reducing them are taken. A wafer surface inspection apparatus is used to detect foreign substances adhered to the wafer surface and defects on the wafer surface in high sensitivity and at high throughput.

The wafer surface inspection apparatus detects the size of foreign substances or defects and position coordinate data of them by radiating electromagnetic waves such as a laser beam onto the wafer surface and receiving light scattered from the foreign substances and defects by a detector. In order to improve the inspection throughput, a laser beam scanning for inspection on the wafer surface is carried out while rotating an inspection table with a wafer loaded on the table at high speed and while moving an inspection table-mounted stage in the uniaxial direction on the same plane as the inspection surface. The surface inspection apparatus, for example, is described in Japanese Patent Laid-open No. 2005-156537 (Patent Document 1).

The light (light beam) is obliquely radiated onto the wafer surface in general to detect minute foreign substances. A scanning with the radiated light beam is carried out in spiral or in circular on the wafer surface due to the rotation of the inspection table aforementioned.

When the scanning light beam is radiated onto a chamfered area (for example, a non-flat surface edge such as a rounded edge or an edge with an inclined surface) of the wafer, a strong light scattered upward from there is generated due to the non-flatness thereof, and the upward scattered light is detected with the detector, and the resulting detected light becomes a noise component. In order to cancel the noise component, for example, scattered light is detected in a plurality of directions, and a calculation for the noise cancellation is executed using information obtained from each detector. The surface inspection apparatus, for example, is described in Japanese Patent Laid-open No. Hei 11 (1999)-351850 (Patent Document 2).

The aforementioned prior art can detect foreign substances and defects by performing the calculation of the scattered light from the edge of an object to be inspected but reduces the throughput of the inspection apparatus all the more because complicated calculation are required. Further, deterioration of the detector due to entry of strong scattered light is not taken into account, so that the running cost to exchange the detector is increased. Furthermore, information as a noise component must be collected in a plurality of directions using a lot of detectors, so that the optical system is complicated, thus the apparatus cannot be made compact and the manufacturing cost is increased.

### SUMMARY OF THE INVENTION

The present invention is to provide an inspection method and an inspection apparatus capable of reducing noise caused by scattered light from the edge portion of the outer periphery of an object to be inspected to a light detector by reducing upward scattering caused by non-flatness from the edge portion, and capable of improving precision of the surface inspection.

The present invention is structured as indicated below to solve the aforementioned object.

A surface inspection apparatus of the present invention comprises a radiation mechanism for radiating a light beam to the surface of an object having an edge of a non-flat surface (for example, a rounded edge) or an edge of an inclined surface, a scanning mechanism for moving the object relative to a radiation position of the light beam for scanning, and a detector for detecting light scattered from the object, and further includes the following characteristic.

The scanning mechanism, when the light beam for scanning is radiated to the edge of the object, is configured to move the object in the direction that increases an incident angle of the light beam with a normal to the surface of the edge as the objection moves relative to a radiation position of the light beam.

In another view point of the present invention, the surface inspection apparatus is constructed as follows. The apparatus comprises a radiation mechanism for radiating a light beam to the surface of an object to be inspected, a scanning mechanism for moving the object relative to a radiation position of the light beam for scanning, and a detector for detecting light scattered from the object, and further includes the following characteristic.

The scanning mechanism, when the light beam for scanning is radiated to the edge of the object, is configured to move the object in the direction that does not increase the scattered light beam toward the detector as the objection moves relative to a radiation position of the light beam.

Another surface inspection apparatus or method which detects light scattered from an object while moving the object relative to a radiation position of the light beam for scanning,

wherein the apparatus or method is configured to stop radiation of the light beam just before the radiation position of the light beam reaches the edge portion of the object, by recognizing a movement position of the object relative to a radiation position of the light beam.

A further another surface inspection apparatus, which detects light scattered from an object while moving the object relative to a radiation position of the light beam for scanning, comprises a detector for detecting the scattered light, a position recognition device for recognizing a movement position of the object relative to the radiation position of the light beam, and a detector stopping device for stopping a function of the detector just before the radiation position of the light beam reaches the edge portion of the object.

A further another surface inspection apparatus, which detects light scattered from an object while moving the object relative to a radiation position of the light beam for scanning, comprises a detector for detecting the scattered light, a position recognition device for recognizing a movement position of the object relative to the radiation position of the light beam, and a protector device for protecting the detector from the scattered light just before the radiation position of the light beam reaches the edge portion of the object.

According to the present invention, it is possible to reduce upward-scattered light (noise component) traveling from the edge portion of the object to be inspected to the light detector when the light beam scans onto the non-flat edge portion of the object, and possible to prevent the detector-deterioration caused by the scattered light.

### BRIEF DESCRIPTION OF THE DRAWINGS

FIG. 1 is a plane view showing the schematic constitution of the surface inspection apparatus relating to an embodiment of the present invention,

FIG. 2 is a front view showing the internal constitution of the inspection section of the surface inspection apparatus,

FIG. 3(a) is a drawing showing the constitution of the light radiation section in a plane shape and FIG. 3(b) is a view in the A-A direction,

FIG. 4 is a drawing showing the relationship between a track 2 of movement of a wafer 1 during inspection and a radiation direction 458 of a laser beam,

FIG. 5(a) is a drawing showing an edge of the wafer, FIG. 5(b) is a drawing showing the state (1) that the laser beam is radiated to the edge portion which is not flat,

FIG. 6(a) is a drawing showing the state (2) that the laser beam is radiated to the edge portion which is not flat, FIG. 6(b) is a drawing showing the relationship between the radiation direction of the laser beam and inspection starting on the wafer,

FIG. 7 is a drawing when an angle θb1 formed by the movement direction 2 of the wafer 1 with the radiation direction of the laser beam 458 is between 90° and 270°,

FIG. 8 is a drawing when an angle θb2 formed by the track 2 of movement of the wafer 1 with the radiation direction of the laser beam 458 is between 0° and 90° and between 270° and 360°,

FIG. 9 is a drawing showing an embodiment when a shutter is installed on the light detector,

FIG. 10 is a drawing showing an embodiment when the function of the light detector is stopped,

FIG. 11 is a drawing showing an embodiment when assuming the inspection start position as the outer peripheral part of the wafer 1 and scanning toward the wafer center,

FIG. 12 is a drawing showing an embodiment when blocking the light path of the inspection apparatus by a shutter 452,

FIG. 13 is a drawing showing the screen for setting an unmeasurable range of an object to be inspected in the surface inspection apparatus, and

FIG. 14 is a drawing showing the screen for setting an unmeasurable range of an object to be inspected in the surface inspection apparatus.

### DETAILED DESCRIPTION OF THE INVENTION

The inspection method and inspection apparatus of the present invention can be applied to a flat surface of an object to be inspected such as a glass substrate for a semiconductor wafer and a liquid crystal panel, a disk substrate, or an ALTIC (a calcined material of alumina and titanium carbide) substrate used for manufacture of a magnetic head, though in this one embodiment, a semiconductor wafer is used as an example and the embodiments of the present invention will be explained below with reference to the accompanying drawings.

Further, the inspection apparatus can check the presence or absence of foreign substances and defects on the front side and the back side of a wafer surface, though the wafer surface which is the side to be inspected, that is, the inspection surface is referred to as the surface for convenience.

### First Embodiment

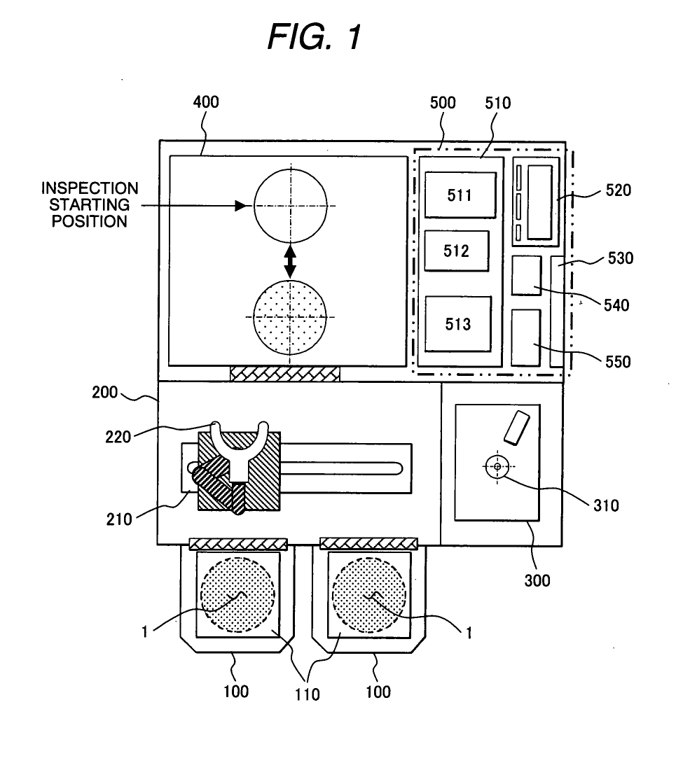

FIG. 1 is a plane view showing the schematic constitution of the surface inspection apparatus of an embodiment of the present invention. The surface inspection apparatus is composed of one or more load ports 100 serving as a loading function of an object (wafer) to be inspected, a conveying section 200, a pre-alignment section 300, an inspection section 400, and a data processing unit 500.

In the load ports 100, one or more wafer pods 110 serving as a function storing a plurality of wafers 1 to be inspected are loaded. The wafers of the load ports 100 are conveyed to the inspection section 400 via the pre-alignment section 300 by the conveying section 200. It is possible to use all the load ports 100 as pods for the objects to be inspected and to use a part of them as collection exclusive pods 110 of wafers 1 decided as defective by the inspection.

The data processing unit 500 is composed of a controller 510, an input unit 520 having a keyboard, a touch panel, or a mouse, a display unit 530 having a CRT or a flat panel display for displaying visually, an output unit 540 such as a printer, and an external storage unit 550 for controlling external media.

Further, the controller 510 is composed of a processing unit 511, a storage unit 512 such as an HDD, and a control unit 513. The controller 510 controls the entire foreign inspection apparatus on the basis of an instruction from the input unit 520. Conditions for inspection set by the input section, inspection results, and operation states of the inspection apparatus are displayed on the display unit 530. The output unit 540 outputs the concerned information.

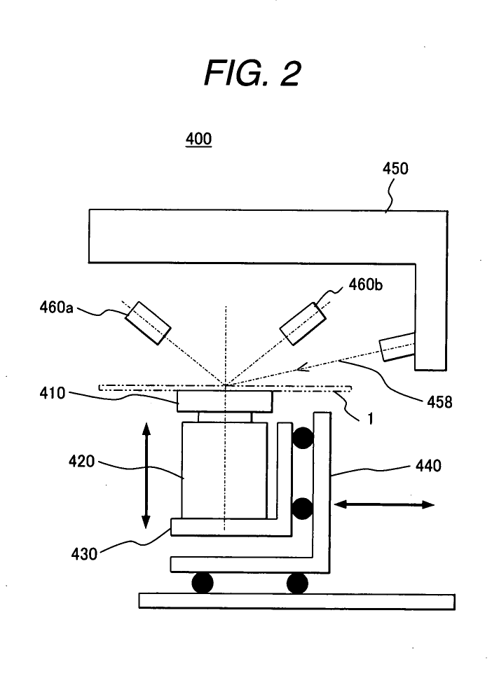

FIG. 2 is a longitudinal cross sectional view showing the internal constitution of the inspection section 400.

The inspection section 400 is composed of:

a holder 410 for holding the wafer 1;

a rotation driving mechanism 420 with a rotation unit (not shown) such as a spindle motor for rotating the holder 410 and an angular position detector (not shown) having an encoder;

an up-and-down mechanism 430 for moving up and down the holder 410;

a linearly movable mechanism (linear driving mechanism) 440 which is capable of moving the holder 410, the rotation driving mechanism 420, and the up-and-down mechanism 430 together with each other in the direction that is almost parallel to the surface of the wafer 1, and that includes a position recognition device (not shown) for recognizing the movement position of the wafer 1 relative to the radiation position of a light beam 458;

a light radiation section 450 for radiating the light (light beam) 458; and

a light detector 460 for detecting scattered light from the surface of the wafer 1.

The light radiation section 450 is radiates the light beam 458 for example, electromagnetic waves such as a visual laser beam or an ultraviolet laser beam to the surface of the wafer 1. The light detector 460 may be singular or plural and in this embodiment, as an example, two detectors (460a, 460b) are arranged.

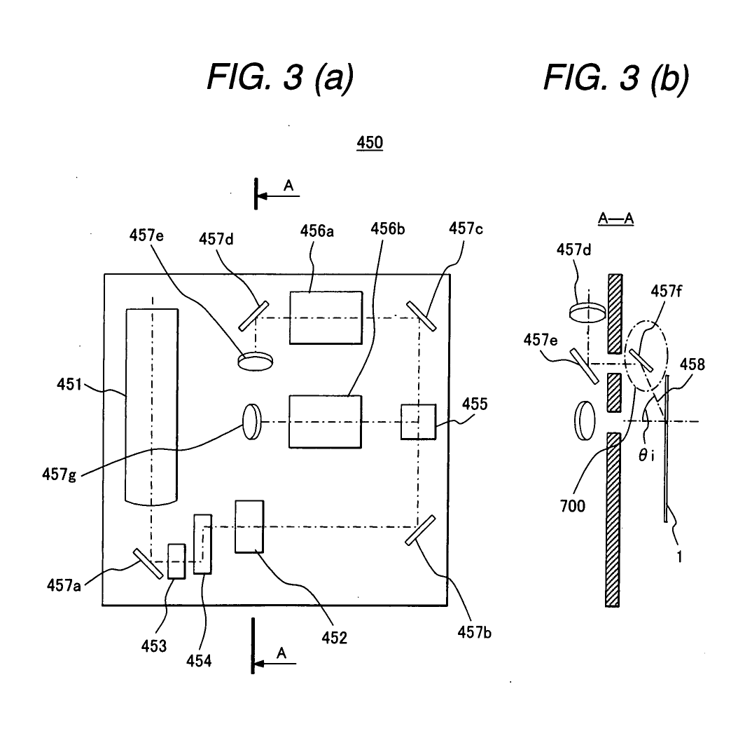

FIG. 3(a) and 3(b) are a drawing showing the schematic constitution of the light radiation section 450. The light radiation section 450 (radiation mechanism), as shown in FIG. 3(a) and 3(b), is composed of a laser beam source 451 for generating the light beam 458, a shutter 452 for cutting off the laser beam, an attenuator 453 for adjusting the intensity of the laser beam 458, an optical axis alignment mechanism 454 for aligning the optical axis of the laser beam 458, a radiation direction switching mechanism 455 for switching obliquely or vertically the radiation direction of the laser beam 458, beam forming mechanisms 456a and 456b for forming the cross-sectional shape of the laser beam 458 in a desired shape, and mirrors 457a to 457g for changing the travel direction of the laser beam 458 (radiating mechanism).

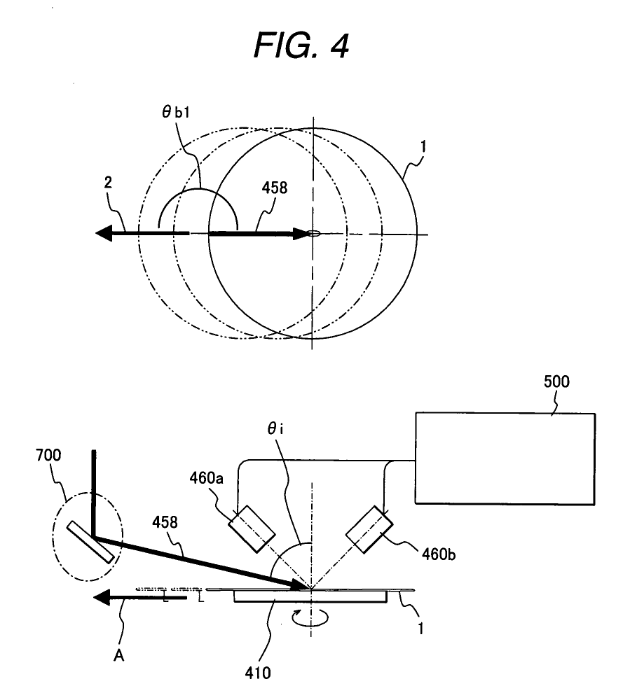

The laser beam 458 is emitted from the laser beam source 451 and is adjusted to energy density suited to inspection by the attenuator 453 via the mirror 457a. Next, it is shaped to the cross-sectional shape suited to the inspection object by the beam forming mechanism 456 via the optical axis alignment mechanism 454 for aligning the shift of the optical axis and the mirrors 457b and 457c, and then is changed in the travel direction thereof sequentially via the mirrors 457d to 457f, and is radiated to the wafer 1. Further, the laser beam 458 manually is controlled to a desired radiation angle θi (see to FIG. 4) with the normal to the reference surface of the holder 410 or to the flat surface of the wafer 1, by adjusting manually or automatically controlling the angle of the mirror 457f beforehand at an emission unit 700 with a radiation angle controller (not shown).

Next, the processing flow of the surface inspection apparatus in this embodiment will be explained in detail. The inspection of the wafer 1 is started by execution of the inspection program. The wafer 1 is took out from the wafer pod 110 by a handling arm 220 arranged in a conveyor 210 in the conveying section 200 and is conveyed from the load port 100 to the pre-alignment section 300.

Concerning the wafer 1 arranged on a loading section 310 of the pre-alignment section 300, a rough position alignment (pre-alignment) between the almost central position of the wafer 1 and a notch position is performed. The pre-aligned wafer 1 is taken out again by the handling arm 220, is conveyed to the wafer holder 410 arranged in the inspection section 400, and is held on the wafer holder 410.

A starting position for surface inspection of the wafer is aligned so as to radiate the light beam to the pre-calculated center position of the wafer 1 by controlling the up-and-down mechanism 430 and the linear driving mechanism 440 in accordance with an inspection start command from the controller 510. The rotation driving mechanism 420 starts the rotation of the wafer holder 410 before alignment of the starting position, and increases the number of rotations in parallel with the operation of starting position alignment, thereby shortens the necessary time for the surface inspection. The controller 510 controls the rotation driving mechanism 420 so as to reach a predetermined number of rotations almost at time of completion of the position alignment and drives it at the predetermined number of rotations.

The wafer 1 held by the holder 410 is rotated at high speed by the rotation driving mechanism 420, and is moved linearly by the linear driving mechanism 440 in the uniaxial direction that is almost in parallel with the surface of the wafer 1 while the laser beam 458 is being radiated to the surface of the wafer 1. Thus the laser beam 458 relatively moves in a spiral, a swirl, or a circle, and scans the inspection surface at high speed (scanning mechanism). When there are at least one of foreign substances or defects on the wafer 1, light scattered from foreign substances and defects on the wafer 1 by radiation of the laser beam 458 is received by the detectors 460a and 460b. The sizes of foreign substances or/and defects and their position coordinates in the wafer 1 are recognized by that the controller 510 analyzes data of the detected scattered light, relative movement position information of the linear driving mechanism 440 and rotation driving mechanism 420 from the position recognition device.

The wafer 1 after surface inspection is taken out again by the handling arm 220, is conveyed from the wafer holder 410 to the load port 100, and is stored in the wafer pod 110.

As mentioned above, the laser beam 458 is radiated onto the surface of the wafer 1 by scanning, and when the scattered light is detected, at least one of foreign substances and defects on the wafer surface is detected. An important point of this embodiment is that although the laser beam 458 is radiated the edge portion (here, the rounded edge portion) 11 of the non-flat surface beyond the flat wafer surface to be inspected, in this case, the scanning mechanism is configured to move the wafer 1 in the direction that increases an incident angle of the light beam 458 with a normal to the surface of the edge 11 as the wafer 1 moves relative to the radiation position of the light beam.

FIG. 4 shows the relationship between the track 2 of movement of the wafer 1 during inspection and the radiation direction of the laser beam 458. When the position alignment of the wafer holder 410 is completed, the laser beam 458 is radiated to almost the center of the wafer 1 at a predetermined angle by the emission unit 700. The wafer holder 410 moves toward the emission unit 700 for the laser beam 458 in the direction that is almost in parallel with the horizontal line by the movement driving mechanism (linear driving mechanism) 440 while rotating at high speed by the rotation driving mechanism 420. By the linear movement of the wafer holder in the direction of the arrow A (toward the emission unit 700), the radiation position of the laser beam on the surface of the wafer 1 moves and the laser beam enters the scanning state. Namely, in this embodiment, the scanning starts from the inside of the inspection surface of the object 1 and is executed by moving the object toward the emission unit of the laser beam. Reflected scattered light caused by the laser beam 458 radiated to the wafer 1, as mentioned above, is detected by the light detector 460, is A-D converted, and then is processed by the data processing unit 500 together with its detection position coordinates.

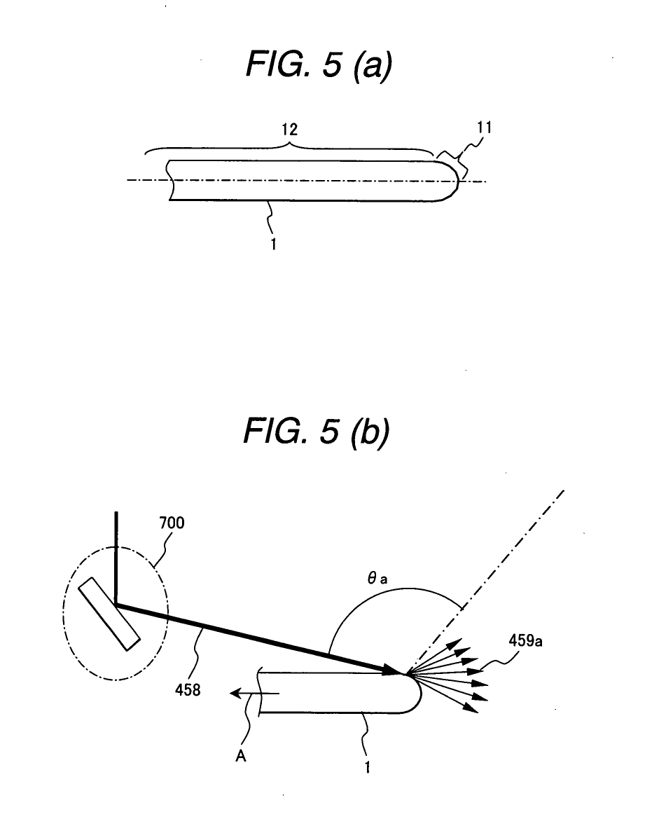

FIG. 5(a) shows a partial cross sectional view of the wafer 1 and FIG. 5(b) shows the laser beam scanning state in the neighborhood of the edge of the wafer 1 shown in FIG. 5(a). In this case, the linear movement direction of the wafer 1 is the direction of the arrow A. On the other hand, the absolute position of the laser beam radiation position is not changed, though the wafer 1 moves in the direction of the arrow A by rotating, so that the laser beam scans the wafer surface. The state that the wafer surface inspection (scanning) by the laser beam progresses and the laser beam 458 is applied to the edge portion 11 of the non-flat wafer 1 is shown in FIG. 5(b). The edge portion 11 indicates a rounded or linearly chamfered portion of the end of the wafer 1 which is called a bevel and the outer peripheral part means the tip portion of the edge of the wafer 1. The laser beam 458 radiated almost to the center of the wafer 1 at first, as the scanning proceeds, gradually moves to the outer peripheral part of the wafer 1, and soon reaches the non-flat edge portion 11.

Here, when the radiation direction of the laser beam 458 and the movement direction of the wafer 1 move relatively in the aforementioned relationship, as the laser beam moves relatively from the flat surface 12 of the wafer surface to the edge portion 11, an incident angle θa formed by the normal of the surface of the wafer 1 with the laser beam 458 is increased gradually. Upward scattering of scattered light caused by the surface of the edge portion 11 is reduced due to the increase in the incident angle θa. Therefore, even if the laser beam 458 scans the edge portion 11 toward the outer peripheral part of the wafer 1, the strong scattered light 459a caused by the surface of the edge portion 11 is prevented from directly entry into the light detector 460, and lowering of the detection sensitivity due to the noise component of the scattered light 459a and deterioration of the light detector 460 can be suppressed.

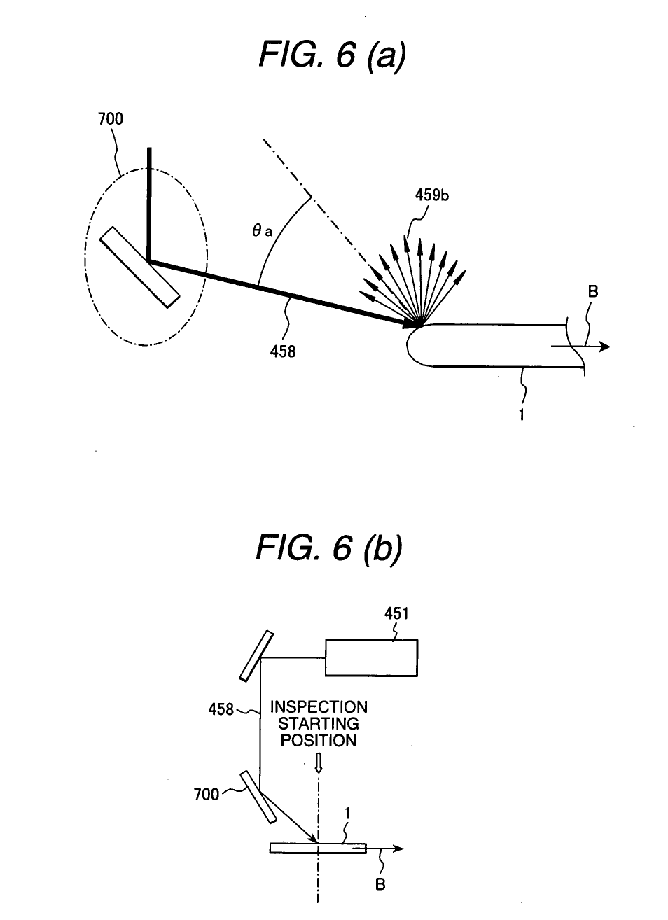

Here, for comparison purposes, assuming that the inspection is executed by moving the linear mechanism 440 in the opposite direction of the aforementioned movement direction, that is, in the direction that the wafer holder 410 and the wafer 1 move away from the emission unit 700 of the laser beam 458, as the laser beam moves relatively from the flat surface 12 to the non-flat edge portion 11, the incident angle θa of the laser beam 458 with the normal of the surface of the wafer 1 is decreased gradually. Therefore, scattered light 459b from the surface of the wafer 1 at the edge portion 11 when the laser beam 458 scans the edge portion 11 toward the outer peripheral part of the wafer 1 increases in upward scattering as shown in FIG. 6(a) and directly enters the light detector 460. By doing this, the scattered light 459b becomes a noise component, thereby causes lowering in the detection sensitivity, and furthermore promotes deterioration of the light detector 460.

Here, the conventional general concept when the laser beam (light beam) is radiated onto the wafer 1 and the surface is inspected will be indicated below.

In the conventional wafer size, since effective wafers are not formed in the neighborhood of the edge portion of each wafer, there is no need to inspect the neighborhood of the edge portion. Therefore, the area from the outer peripheral part of each wafer to a predetermined width in the radial direction is set as an un-inspected range (edge area) and the wafer is inspected without detecting foreign substances adhered to the edge portion. Under the condition of not taking foreign substances on the edge portion into account, as shown in FIG. 6(b), it is a general concept to set the inspection start position (scanning position) of the laser beam at the center of the wafer and to move the wafer 1 in the direction (the direction of the arrow B) that the wafer 1 moves away from the lighting unit (emission unit) 700 (the scanning direction is relatively an opposite direction of the arrow B). Namely, generally, in an inspection apparatus using light, in consideration of maintenance and exchange of the laser beam source, it had been considered preferable to place the lighting unit 700 at an accessible place which is in the neighborhood of outer wall of the apparatus. Further it had been considered preferable for the convenience of conveyance to move the object (wafer) 1 in the direction (the direction of the arrow B) that the object 1 moves away from the outer wall as the inspection starting position and to approach the object 1 to the outer wall at time of return.

However, when effective chips are formed even in the neighborhood of the edge portion due to recent realization of a large diameter (300 mm) of wafers, foreign substances at the edge portion and film peeling which are ignored conventionally have begun to come into a problem as a fatal defect affecting the yield. When it is required to execute the surface inspection at the edge portion in order to meet with such a new needs, if the surface inspection following the conventional concept is executed, a problem as shown in FIG. 6(a) arises.

In this embodiment, in order to solve such a problem, as shown in FIGS. 4 and 5(b), the scanning mechanism, when the laser beam 458 for scanning is radiated to the edge portion of the object, is configured to move the object in the direction that increases an incident angle of the laser beam 458 with a normal to the surface of the edge portion as the objection 1 moves relative to the radiation position of the laser beam 458. In other words, the scanning mechanism is configured to move the object from the center position to be a scanning starting position of the surface in the objection 1 toward the emission unit 700.

In this embodiment, as shown in FIG. 4, the reduction effect on upward scattering is explained under when the inspection starting position (scanning starting position) is set at almost the center of the wafer 1, and when the angle θb1 with the track 2 of movement of the wafer 1 to the radiation direction of the laser beam 458 is 180°. However, the reduction effect on upward scattering is not limited to 180° and even when the angle θb1 is between 90° and 270°, the similar effect can be obtained.

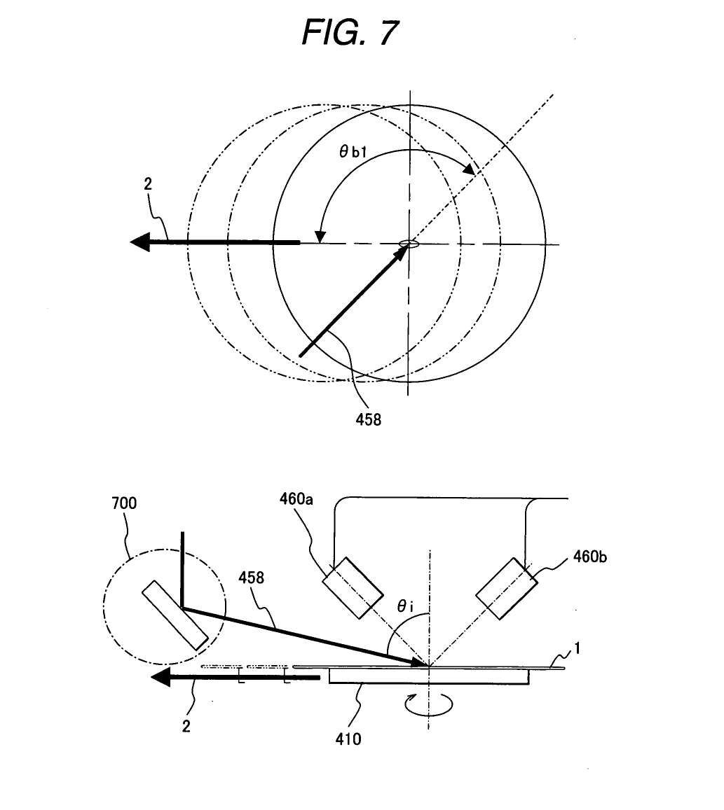

FIG. 7 shows the case that the angle θb1 with the track 2 of movement of the wafer 1 to the radiation direction of the laser beam 458 is between 90° and 270°. Even if the laser beam reaches the non-flat edge portion 11 beyond flat surface 12 of the wafer, the incident angle θa of the laser beam 458 with the normal of the surface of the wafer 1 does not become smaller so long as the angle θb1 is within the range from 90° to 270°. Therefore, the upward scattering of the scattered light 459 is reduced, and thereby direct entry of the laser beam 458 from the edge portion 11 of the wafer 1 into the light detector 460 can be reduced. By this reduction effect, lowering of the detection sensitivity and deterioration of the light detector 460 can be suppressed.

However, when the angle θb1 is 90°, the upward scattering of the scattered light 459 may be increased depending on the roughness of the surface of the wafer 1 at the edge portion 11, so that the angle θb1 to be used is desirably larger than 90°.

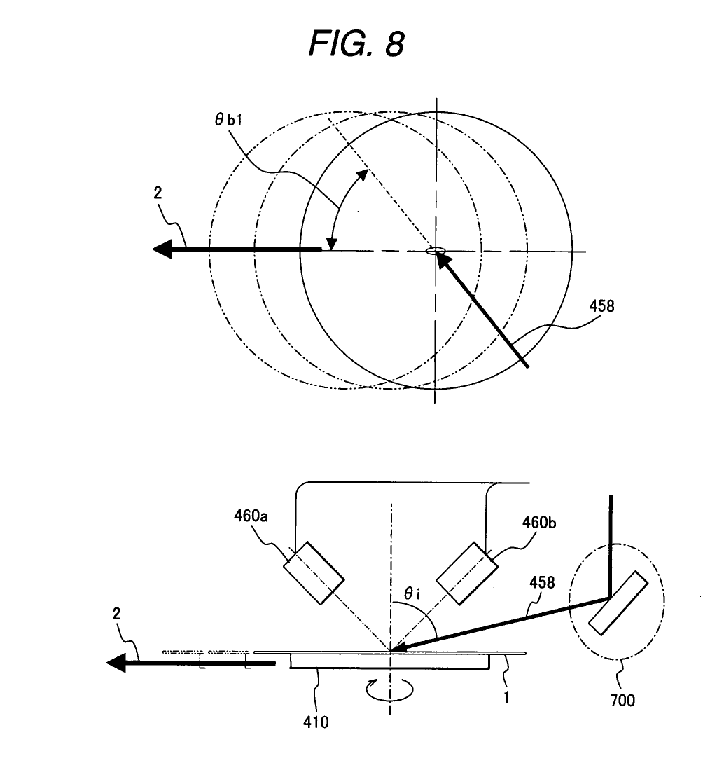

Incidentally, as shown in FIG. 8, when the angle θb1 with the track 2 of movement of the wafer 1 to the radiation direction of the laser beam 458 is between 0° and 90° and between 270° and 360°, when the laser beam 458 reaches the non-flat edge portion 11 beyond the flat surface 12 of the wafer 1, the incident angle θa with the normal of the surface of the edge portion 11 to the laser beam 458 becomes smaller. Therefore, the upward scattering of the scattered light 459 is increased and directly enters the light detector 460, thus increasing of noise and deterioration of the light detector 460 are accelerated.

Therefore, in order to reduce the upward scattering of the scattered light 459, it is necessary to radiate the laser beam 458 in the direction that the angle θb1 with the track 2 of movement of the wafer 1 to the radiation direction of the laser beam 458 is at least other than 0°. Further it is preferable to set effectively the range of the incident angle θa from 90° to 270° where the incident angle θa of the laser beam 458 with the normal of the edge portion 11 is larger than the incident angle θi of laser beam 458 with the normal of the flat surface 12 of the wafer 1. It is more preferable to set desirably the range of θa from 135° to 2250.

### Second Embodiment

In Embodiment 1 aforementioned, the case that the inspection (scanning) starting position is set at almost the center of the wafer 1 and the wafer surface is scanned spirally or circularly toward the outer peripheral part of the wafer 1 is explained.

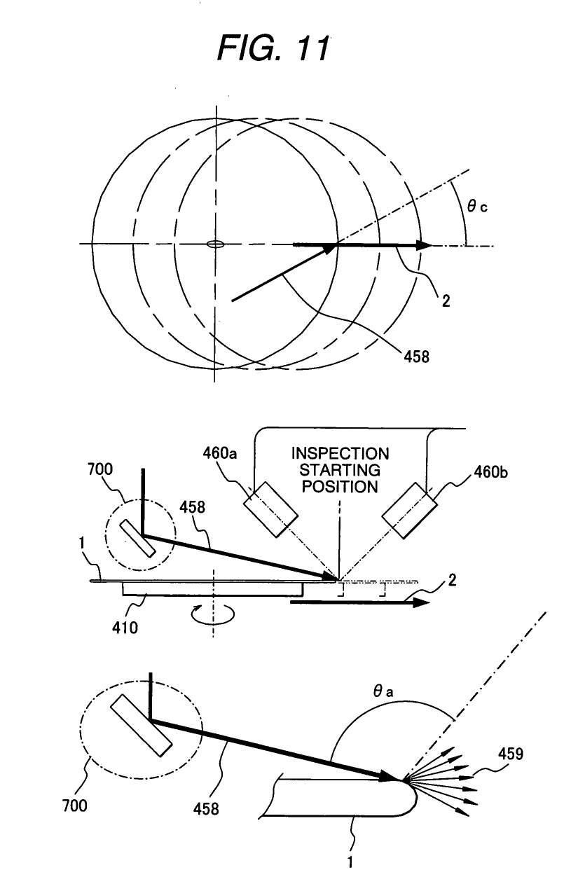

FIG. 11 shows the second embodiment of the present invention, and in this embodiment, the inspection starting position is set at the outer peripheral part of the wafer 1 and the wafer surface is scanned spirally or circularly toward the wafer center. In other words, in this embodiment, the scanning is started from outside the inspection surface of the object 1 and is executed by moving the object in the same or close direction as the radiation direction of the light beam.

The starting position for surface inspection of the wafer is aligned so as to radiate the laser beam to the pre-calculated outer peripheral part of the wafer 1 or the edge portion 11 by controlling the up-and-down mechanism 430 and the linear driving mechanism 440 in accordance with the inspection start command from the controller 510 shown in FIG. 1. The rotation driving mechanism 420 starts the rotation of the wafer holder 410 before alignment of the starting position, and increases the number of rotations in parallel with the operation of starting position alignment, thereby shortens the necessary time for the surface inspection. The controller 510 controls the rotation driving mechanism 420 so as to reach a predetermined number of rotations almost at time of completion of the position alignment and drives it at the predetermined number of rotations.

The wafer 1 held by the holder 410 is rotated at high speed by the rotation driving mechanism 420, and is moved linearly by the linear driving mechanism 440 in the uniaxial direction that is almost in parallel with the surface of the wafer 1 while the laser beam 458 is being radiated to the surface of the wafer 1. Thus the laser beam 458 scans the inspection surface at high speed in a spiral, a swirl, or a circle. When there are at least one of foreign substances or defects on the wafer 1, light scattered from foreign substances and defects on the wafer 1 by radiation of the laser beam 458 is received by the detectors 460a and 460b. The sizes of foreign substances or/and defects and their position coordinates in the wafer 1 are recognized by that the controller 510 analyzes data of the detected scattered light, relative movement position information of the linear driving mechanism 440 and rotation driving mechanism 420 from the position recognition device.

Here, an important point of this embodiment is that the laser beam 458 and wafer 1 are moved relatively in the direction that the incident angle θa of the laser beam 458 with the normal of the edge portion 11 of the wafer 11 is larger than the incident angle θi laser beam 458 with the normal of the flat surface 12 of the wafer 1 when the laser beam 458 is radiated to the edge portion of the wafer 1. Namely, it means that the wafer 1 is moved in the same or close direction as the radiation direction of the laser beam 458. When the laser beam 458 is radiated in the direction for increasing the incident angle θa, the upward scattering of the scattered light 459 caused by the surface of the edge portion 11 is reduced and lowering of the detection sensitivity due to the noise component of the scattered light 459 and deterioration of the light detector 460 can be suppressed.

Further, with respect to the radiating direction of the laser beam 458, when the angle θc with the track 2 of movement of the wafer 1 to the radiation direction of the laser beam 458 is within the ranges from 0° to 90° and from 270° to 360°, the incident angle θa of the laser beam 458 with the normal of the edge portion 11 becomes larger than the incident angle θi of the laser beam 458 with the normal of the flat surface 12 of the wafer 1. Therefore, similarly to Embodiment 1, the upward scattering of the scattered light 459 generated at the edge portion 11 is reduced. Therefore, the scattered light 459 from the surface of the wafer 1 at the edge portion 11 at time of scanning is prevented from direct entry into the light detector 460 and lowering of the detection sensitivity due to the noise component of the scattered light 459 and deterioration of the light detector 460 can be suppressed.

Incidentally, when the angle θc with the track 2 of movement of the wafer 1 to the radiation direction of the laser beam 458 is within the range from 90° to 270°, the incident angle θa of the laser beam 458 with the normal of the edge portion 11 becomes smaller than the incident angle θi of the laser beam 458 with the normal of the flat surface 12 of the wafer 1 and at time of scanning the edge portion 11, upward scattering of the scattered light 459 from the surface of the wafer 1 at the edge portion 11 is increased and directly enters the light detector 460. Therefore, the scattered light 459 becomes the noise component, thereby causes lowering of the detection sensitivity, and furthermore accelerates deterioration of the light detector 460.

Therefore, in order to reduce the upward scattering of the scattered light 459, it is necessary to radiate the laser beam 458 in the direction that the angle θc with the track 2 of movement of the wafer 1 to the radiation direction of the laser beam 458 is at least other than 180°. Further it is preferable to set effectively the range of the incident angle θa from 0° to 90° or from 270° to 360° where the incident angle θa of the laser beam 458 with the normal of the edge portion 11 of the wafer 1 is larger than the incident angle θi the laser beam 458 with the normal of the flat surface 12 of the wafer 1. It is more preferable to set desirably the range of θa from 0° to 45° or from 315° to 360°.

### Third Embodiment

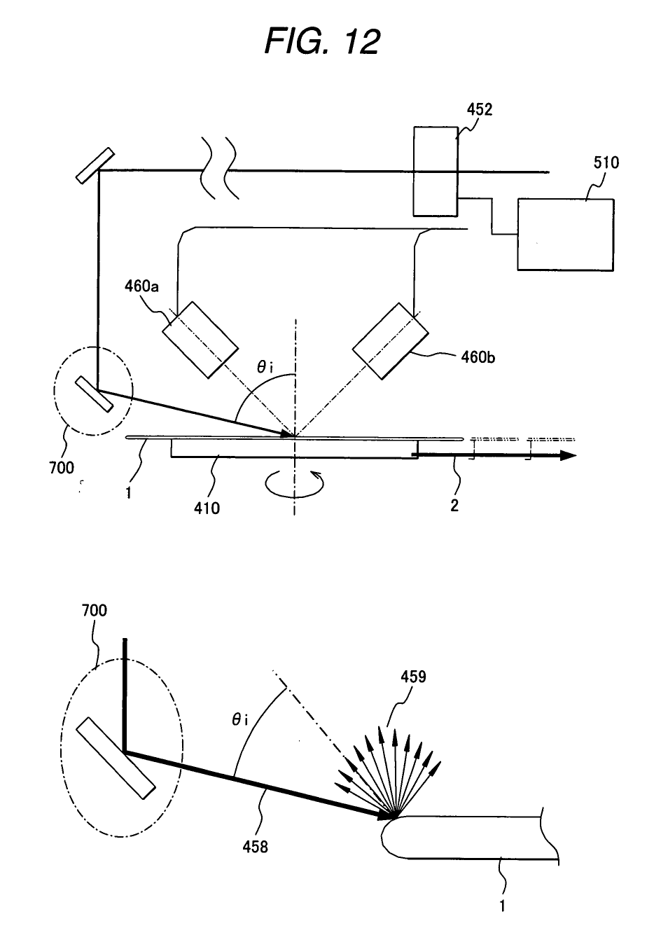

In Embodiments 1 and 2, as deterioration prevention of the light detector 460, the method for reducing the upward scattering of the scattered light 459 at the edge portion 11 is explained, though it is effective to cut off the laser beam 458 before radiation of the laser beam 458 to the edge portion 11. Hereinafter, it will be explained in detail by referring to FIGS. 3, 11, and 12.

In the inspection process of the wafer 1, the optical path of the laser beam is blocked by the light blocking (cut off) mechanism composed of the shutter 452 installed in the radiation section 450 and the radiation of the laser beam 458 is cut off before radiation of the laser beam 458 to the edge portion 11 of the wafer 1, that is, before generation of the upward scattering of the scattered light 459. The position recognition section for the laser beam 458 of the controller 510 calculates the lighting position of the laser beam 458 to the wafer 1 on the basis of a signal from the position detector of the linear driving mechanism 440. The controller 510 controls switching of the shutter 452 in correspondence with a preset position set value. By doing this, even if the inspection starting position of the wafer 1 is set at the center thereof, at the edge portion 11 thereof, or in the outer peripheral space thereof, the influence of the upward scattering from the edge portion 11 can be prevented. Therefore, even when the laser beam 458 reaches (scans) the edge portion 11, generation of the scattered light 459 at the edge portion 11 can be prevented, so that lowering of the detection sensitivity due to the noise component and deterioration of the light detector 460 can be suppressed.

Further, with respect to the third embodiment explained above, not only itself but also combination with the first embodiment or the second embodiment is effective.

Incidentally, information such as the coordinates, diameter, and width of the wafer 1 etc., which is need to determine the position set values for switching the shutter 452, is input through the setting screen installed on the display unit 530 by the input unit 520, and is stored in the storage unit 513. The controller 510 controls switching of the shutter 452 on the basis of the set values.

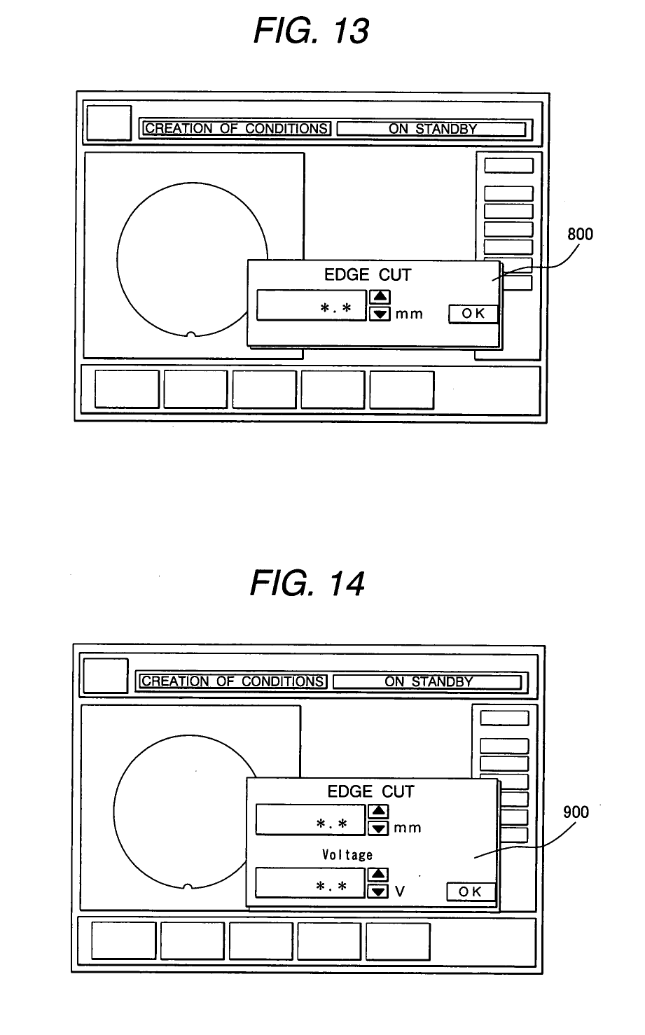

FIG. 13 shows the setting screen of this embodiment. The width of the edge portion 11, which is an area for closing the shutter 452 and for interrupting the radiation of the laser beam 458, can be input via the input unit 520 into a dialog box as un-inspected range input area 800 on the setting screen. The controller 510 calculates a predetermined-linear driving mechanism 440 position to allow the shutter 452 to close on the basis of the width of the edge portion 11. As mentioned above, for the width of the edge portion 11, any coordinates or diameter of the wafer 1 which can identify at least a position in the wafer 1 can be substituted. Further, the width can be set not only in the input dialog box aforementioned but also in another screen opened by an icon or a button provided on the setting screen and any one which can set at least a set value of a position can be substituted.

Further, the position where the scattered light caused by the surface of the edge portion 11 begins to influence for the inspection changes depending on the beam shape of the laser beam 458, the incident angle θi, and the chamfering shape.

It is desirable to cut off the laser beam 458 at the position of the wafer surface inside than the chamfer (the bevel) at the edge of the wafer 1, and it is desirable to cut off the laser beam 458 at the position preferably with a width of 2 to 5 mm from the outer peripheral part of the wafer 1 and more preferably with a width of 2.5 to 3.5 mm from the outer peripheral part.

### Fourth Embodiment

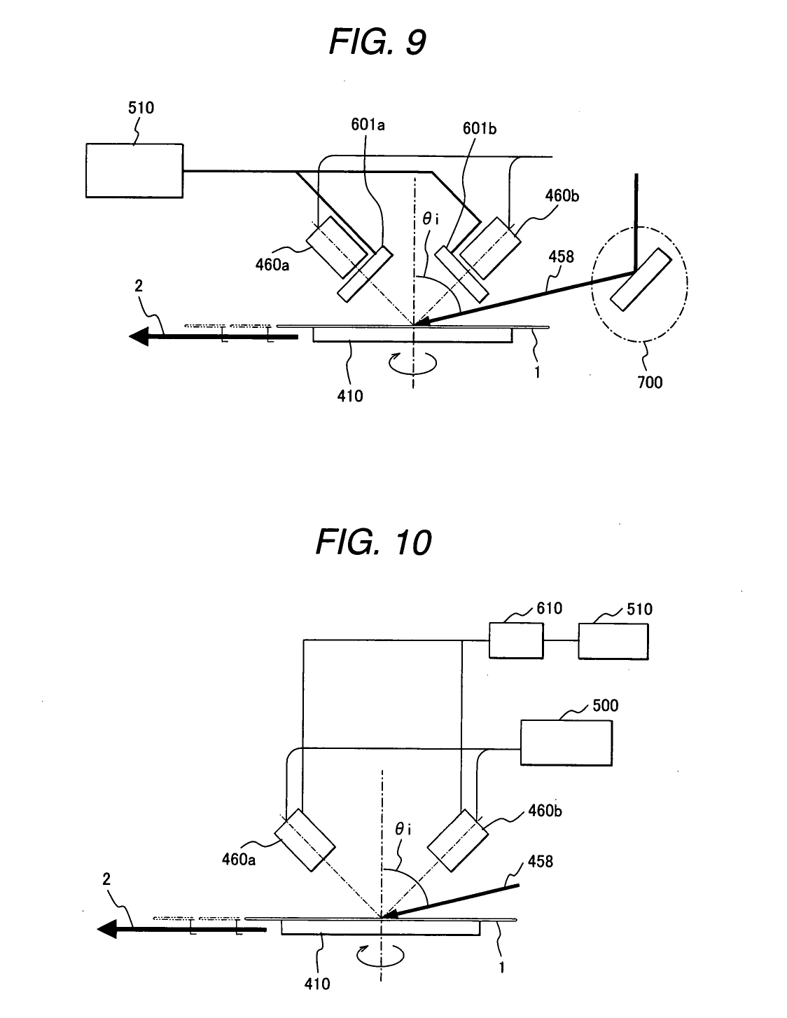

Further, as another method for preventing deterioration of the light detector 460, it is an effective means to block the scattered light 459 entering the light detector 460. Hereinafter, it will be explained in detail by referring to FIG. 9.

The light beam cut off mechanism composed of shutters 601a and 601b is installed in front of the light detector 460 (460a, 460b) in the inspection section 400.

In the inspection, the entry of the scattered light 459 into the light detector 460 is cut off before radiation of the laser beam 458 to the edge portion 11 of the wafer 1, that is, before generation of the upward scattered light 459 by the edge portion 11, on the basis of a signal from the position detector of the linear driving mechanism 440. The position recognition section for the laser beam 458 of the controller 510 calculates the lighting position of the laser beam 458 to the wafer 1 on the basis of a signal from the position detector of the linear driving mechanism 440. The controller 510 controls switching of the shutters 601a and 601b in correspondence with a preset position set value. By doing this, even if the inspection starting position of the wafer 1 is set at the center thereof, at the edge portion 11 thereof, or in the outer peripheral space thereof, the influence of the upward scattering generated from the edge portion 11 can be prevented. Therefore, even when the laser beam 458 reaches the edge portion 11, entry of the scattered light 459 generated at the edge portion 11 into the light detectors 460a and 460b can be prevented, so that lowering of the detection sensitivity due to the noise component and deterioration of the light detectors 460a and 460b can be suppressed.

### Further, with respect to the fourth embodiment explained above, not only itself but also combination with the first embodiment or the second embodiment is effective.

Further, similarly to Embodiment 3, information such as the coordinates, diameter, and width of the wafer 1 etc., which is need to determine the position set values for switching the shutters 601a and 601b, is input through the setting screen installed on the display unit 530 by the input unit 520, and is stored in the storage unit 513. The controller 510 controls switching of the shutter 601a and 601b on the basis of the set values.

Further, the position where the scattered light caused by the surface of the edge portion 11 begins to influence for the inspection changes depending on the beam shape of the laser beam 458, the incident angle θi, and the chamfering shape.

It is desirable to block entry of the laser beam 458 into the light detector 460 at the position of the wafer surface inside than the chamfer (the bevel) at the edge of the wafer 1, and it is desirable to block entry of the laser beam 458 into the light detector 460 at the position preferably with a width of 2 to 5 mm from the outer peripheral part of the wafer 1 and more preferably with a width of 2.5 to 3.5 mm from the outer peripheral part.

### Fifth Embodiment

Further, similarly, as still another method for preventing deterioration of the light detector 460, it is an effective means to stop the function of the light detector 460 before generation of the scattered light 459 from the laser beam 458 radiated to the edge portion 11. Hereinafter, it will be explained in detail by referring to FIGS. 10 and 14.

In the inspection process of the wafer 1, The function of the light detectors 460a and 460b is stopped or the photoelectric conversion sensitivity is lowered before radiation of the laser beam 458 to the edge portion 11 of the wafer 1, that is, before generation of the upward scattering of the scattered light 459. The position recognition section of the laser beam 458 of the controller 510 calculates the lighting position of the laser beam 458 to the wafer 1 on the basis of a signal from the position detector of the linear driving mechanism 440. The controller 510 controls the light detectors 460a and 460b via the detector control means composed of a light detector driving section 610 in correspondence with a preset position set value. By doing this, even if the inspection starting position of the wafer 1 is set at the center thereof, at the edge portion 11 thereof, or in the outer peripheral space thereof, the influence of the upward scattering generated from the edge portion 11 can be suppressed. Therefore, even when the laser beam 458 reaches (scans) the edge portion 11, generation of the scattered light 459 at the edge portion 11 can be prevented, so that lowering of the detection sensitivity due to the noise component and deterioration of the light detector 460 can be suppressed.

Further, with respect to the fifth embodiment explained above, not only itself but also combination with the first embodiment or the second embodiment is effective.

Incidentally, information such as the coordinates, diameter, and width of the wafer 1 etc., which is need to determine the position set values for controlling the light detectors 460a and 460b, is input through the setting screen installed on the display unit 530 by the input unit 520, and is stored in the storage unit 513. The controller 510 controls the light detectors 460a and 460b on the basis of the set values.

FIG. 14 shows the setting screen of this embodiment. The width of the edge portion 11 and a photoelectric conversion sensitivity can be input via the input unit 520 into a dialog box as un-inspected range input area 900 on the setting screen. The width of the edge portion 11 is an area where functions of such as the photoelectric conversion sensitivities the light detectors 460a and 460b are controlled by a light detector driving section 610. That is, the controller 510 calculates predetermined linear driving mechanism 440-position related to control the photoelectric conversion sensitivities of the light detectors 460a and 460b on the basis of the width of the edge portion 11. As mentioned above, for the width of the edge portion 11, any coordinates or diameter of the wafer 1 which can identify at least a position in the wafer 1 can be substituted. Further, the width can be set not only in the input dialog box aforementioned but also in another screen opened by an icon or a button provided on the setting screen and any one which can set at least a set value of a position can be substituted.

Further, the position where the scattered light caused by the surface of the edge portion 11 begins to influence for the inspection changes depending on the beam shape of the laser beam 458, the incident angle θi, and the chamfering shape.

It is desirable to drive the detector control section to control the functions of the light detectors at the position of the wafer surface inside than the chamfer (the bevel) at the edge of the wafer 1, and it is desirable to drive the detector control section at the position preferably with a width of 2 to 5 mm from the outer peripheral part of the wafer 1 and more preferably with a width of 2.5 to 3.5 mm from the outer peripheral part.

In the above-mentioned embodiments, the apparatuses although are the foreign substance inspection apparatus relating to manufacture of semiconductor devices and the objects to be inspected are semiconductor wafers, the art of the present invention is not limited to the semiconductor wafers and any flat substrate such as a glass substrate used for a liquid crystal panel, an ALTIC substrate, and a sapphire substrate used for a sensor and an LED can be used.

Further, the present invention is not limited to the semiconductor device and can be widely applied to various manufacturing processes such as a hard disk, a liquid crystal panel display unit, and various sensors.

What is claimed is:

1. A surface inspection apparatus comprising:
a radiation mechanism for radiating a light beam to a surface of an object having an edge of a non-flat surface or an edge of an inclined surface,
a scanning mechanism for moving the object relative to the radiation position of the light beam for scanning, and
a detector for detecting light scattered from the object,
wherein the scanning mechanism, when the light beam for scanning is radiated to the edge of the object, is configured to move the object in the direction that increases an incident angle of the light beam with a normal to the surface of the edge as the objection moves relative to a radiation position of the light beam.

2. A surface inspection apparatus comprising
a radiation mechanism for radiating a light beam to a surface of an object to be inspected,
a scanning mechanism for moving the object relative to a radiation position of the light beam for scanning, and
a detector for detecting light scattered from the object,
wherein the scanning mechanism, when the light beam for scanning is radiated to the edge of the object, is configured to move the object in the direction that does not increase the scattered light beam toward the detector as the objection moves relative to a radiation position of the light beam.

3. The surface inspection apparatus according to claim 1 or 2,
wherein the scanning mechanism is composed of a mechanism for relatively moving the object to the light beam, and
the scanning mechanism is set to start scanning from an inside of an inspected surface of the object and to scan by moving the object toward an emission unit of the light beam.

4. The surface inspection apparatus according to claim 1 or 2,
wherein the scanning mechanism is composed of a mechanism for relatively moving the object to the light beam, and,
the scanning mechanism is set to start scanning from an outside of an inspected surface of the object and to scan by moving the object in the same direction as a radiation direction of the light beam.

5. A surface inspection method comprising steps of:
scanning a surface of an object having an edge of a non-flat surface or an inclined surface by radiating a light beam to the surface, and
detecting light scattered from the object,
wherein, when the light beam for scanning is radiated to the edge of the object, the scanning is executed so as to move the object in the direction that increases an incident angle of the light beam with a normal to the surface of the edge as the objection moves relative to a radiation position of the light beam.

6. A surface inspection method comprising steps of:
scanning a surface of an object by radiating a light beam to the surface, and
detecting light scattered from the object,
wherein the scanning is executed by moving relatively the object to a radiation position of the light beam, and
wherein a movement direction of the object is set to a direction that does not increase the scattered light beam toward the detector as the objection moves relative to a radiation position of the light beam when the light beam for scanning is radiated to the edge of the object.

7. A surface inspection apparatus which scans a surface of an objection with radiation of a light beam and detects light scattered from the object, comprising:
a holder for holding the object;
a rotation driving mechanism for rotating the holder;
a linear driving mechanism for linearly moving the holder for scanning of the light beam;
a position recognition device for recognizing a relative radiation position of the light beam to movement of the holder, and
a light stopping device for stopping radiation of the light beam in accordance with a predetermined relative position of the light beam to the holder.

8. A surface inspection method which scans a surface of an objection with radiation of a light beam and detects light scattered from the object, comprising steps of:
recognizing a movement position of the object relative to an radiation position of the light beam, and
stopping radiation of the light beam before the radiation position of the light beam reaches an edge portion of the object.

9. A surface inspection apparatus which scans a surface of an objection with radiation of a light beam and detects light scattered from the object, comprising:
a holder for holding the object;
a rotation driving mechanism for rotating the holder;
a linear driving mechanism for linearly moving the holder for scanning of the light beam;
a position recognition device for recognizing a movement position of the object relative to an radiation position of the light beam, and
a block device for blocking entry of scattered light into a detector for detecting the scattered light in accordance with a predetermined relative position of the light beam to the holder.

10. A surface inspection method which scans a surface of an objection with radiation of a light beam and detects light scattered from the object, comprising steps of:
recognizing a movement position of the object relative to an radiation position of the light beam, and
blocking entry of scattered light into a detector for detecting the scattered light in accordance with a predetermined relative position of the light beam to the holder.

11. A surface inspection apparatus which scans a surface of an objection with radiation of a light beam and detects light scattered from the object, comprising:
a holder for holding the object;
a rotation driving mechanism for rotating the holder;
a linear driving mechanism for linearly moving the holder for scanning of the light beam;
a position recognition device for recognizing a movement position of the object relative to an radiation position of the light beam, and a relative radiation position of the light beam to movement of the holder, and
an optical path cut of-device for cutting off an optical path of the light beam in accordance with a predetermined relative position of a radiation position of the light beam relative to the holder.

12. A surface inspection method which scans a surface of an objection with radiation of a light beam and detects light scattered from the object, comprising steps of:
recognizing a movement position of the object relative to an radiation position of the light beam, and
cutting off an optical path of the light beam before the relative radiation position of the light beam reached an edge portion of the object.

13. A surface inspection apparatus which scans a surface of an objection with radiation of a light beam and detects light scattered from the object, comprising:
a holder for holding the object;
a rotation driving mechanism for rotating the holder;
a linear driving mechanism for linearly moving the holder for scanning of the light beam;
a position recognition device for recognizing a movement position of the object relative to an radiation position of the light beam, and
a detector control device for stopping a function of a detector for detecting scattered light in accordance with a predetermined relative position of the light beam to the holder.

14. A surface check method for scanning and radiating a light beam on a surface of an object to be checked and detecting scattered light from said checked object, comprising the steps of:
A surface inspection method which scans a surface of an objection with radiation of a light beam and detects light scattered from the object, comprising steps of:
recognizing a movement position of the object relative to an radiation position of the light beam, and
stopping a function of a detector for detecting scattered light in accordance with a predetermined relative position of the light beam to the holder.
